(19) United States
(12) Patent Application Publication
(10) Pub. No.: US 2009/0201793 A1
(43) Pub. Date: Aug. 13, 2009

(54) MASTER SUBSTRATE AND METHOD OF MANUFACTURING A HIGH-DENSITY RELIEF STRUCTURE

(75) Inventors: Erwin Rinaldo Meinders, Eindhoven (NL); Rolf Antonie Loch, Enschede (NL)

Correspondence Address: Muncy, Geissler, Olds & Lowe, PLLC, P.O. BOX 1364, FAIRFAX, VA, 22038-1364, US

(73) Assignee: KONINKLIJKE PHILIPS ELECTRONICS, N.V., EINDHOVEN (NL)

(21) Appl. No.: 11/577,034

(22) PCT Filed: Oct. 12, 2005
(86) PCT No.: PCT/IB05/53355

§ 371 Date: Apr. 11, 2007

(30) Foreign Application Priority Data
Oct. 19, 2004 (EP) 04105155.8

(51) Int. Cl. G11B 3/70; B29D 11/00

(52) U.S. Cl. 369/283; 264/1.36

(57) ABSTRACT

The present invention relates to a recording stack for obtaining a high-density relief structure, comprising: a first recording layer (10) on top of a second recording layer (12), the recording layers being supported by a substrate layer (14), wherein, upon projecting light on the recording layers, a local interaction of the recording layers leads to marks (16) on the basis of a local change of the properties with respect to chemical agents of the recording layers. The present invention further relates to a method of manufacturing a relief structure and a method of producing an optical data carrier.

### FIELD OF THE INVENTION

The present invention relates to a master substrate and to a method of manufacturing a high-density relief structure.

### BACKGROUND OF THE INVENTION

Relief structures that are manufactured on the basis of optical processes can, for example, be used as a stamper for the mass-replication of read-only memory (ROM) and pre-grooved write-once (R) and rewritable (RE) discs. The manufacturing of such a stamper, as used in a replication process, is known as mastering.

In conventional mastering, a thin photosensitive layer, spincoated on a glass substrate, is illuminated with a modulated focused laser beam. The modulation of the laser beam causes that some parts of the disc are being exposed by UV light while the intermediate areas in between the pits remain unexposed. While the disc rotates, and the focused laser beam is gradually pulled to the outer side of the disc, a spiral of alternating illuminated areas remains. In a second step, the exposed areas are being dissolved in a so-called development process to end up with physical holes inside the photo-resist layer. Alkaline liquids such as NaOH and KOH are used to dissolve the exposed areas. The structured surface is subsequently covered with a thin Ni layer. In a galvanic process, this sputter-deposited Ni layer is further grown to a thick manageable Ni substrate with the inverse pit structure. This Ni substrate with protruding bumps is separated from the substrate with unexposed areas and is called the stamper.

ROM discs contain a spiral of alternating pits and lands representing the encoded data. A reflection layer (metallic or other kind of material with different index of refraction coefficient) is added to facilitate the readout of the information. In most of the optical recording systems, the data track pitch has the same order of magnitude as the size of the optical readout/write spot to ensure optimum data capacity. Compare for example the data track pitch of 320 nm and the 1/e spot radius of 305 nm (1/e is the radius at which the optical intensity has reduced to 1/e of the maximum intensity) in case of Blue-ray Disc (BD). In contrary to write-once and rewritable optical master substrates, the pit width in a ROM disc is typically half of the pitch between adjacent data tracks. Such small pits are necessary for optimum readout. It is well known that ROM discs are read out via phase-modulation, i.e. the constructive and destructive interference of light rays. During readout of longer pits, destructive interference between light rays reflected from the pit bottom and reflected form the adjacent land plateau occurs, which leads to a lower reflection level.

Mastering of a pit structure with pits of approximately half the optical readout spot typically requires a laser with a lower wavelength than is used for readout. For CD/DVD mastering, the Laser Beam Recorder (LBR) typically operates at a wavelength of 413 nm and numerical aperture of the objective lens of NA=0.9. For BD mastering, a deep UV laser with 257 nm wavelength is used in combination with a high NA lens (0.9 for far-field and 1.25 for liquid immersion mastering). In other words, a next generation LBR is required to make a stamper for the current optical disc generation. An additional disadvantage of conventional photoresist mastering is the cumulative photon effect. The degradation of the photo-sensitive compound in the photoresist layer is proportional to the amount of illumination. The sides of the focused Airy spot also illuminates the adjacent traces during writing of pits in the central track. This multiple exposure leads to local broadening of the pits and therefore to an increased pit noise (jitter). Also for reduction of cross-illumination, an as small as possible focused laser spot is required. Another disadvantage of photoresist materials as used in conventional mastering is the length of the polymer chains present in the photoresist. Dissolution of the exposed areas leads to rather rough side edges due to the long polymer chains. In particular in case of pits (for ROM) and grooves (for pre-grooved substrates for write-once (R) and rewritable (RE) applications) this edge roughness may lead to deterioration of the readout signals of the pre-recorded ROM pits and recorded R/RE data.

According to a recently developed concept, high-density relief structures can be produced in the basis of phase-transition mastering (PTM). Phase-transition materials can be transformed from the initial unwritten state to a different state via laser-induced heating. Heating of the recording stack can, for example, cause mixing, melting, amorphisation, phase-separation, decomposition, etc. One of the two phases, the initial or the written state, dissolves faster in acids or alkaline development liquids than the other phase does. In this way, a written data pattern can be transformed to a high-density relief structure with protruding bumps or pits. The patterned substrate can be used as stamper for the mass-fabrication of high-density of optical discs or as stamp for micro-contact printing. It has been proposed to use fast-growth phase-change materials and recording stacks for phase-transition mastering. The growth-dominated phase-change materials possess a high contrast in dissolution rate of the amorphous and crystalline phase. The amorphous marks, obtained by melt-quenching of the crystalline material, can be dissolved in concentrated conventional alkaline developer liquids, such as KOH and NaOH but also in acids like HCl, HNO₃ and H₂SO₄. Re-crystallization in the tail of the mark was used to reduce the mark length in a controlled manner. In particular in case of the smallest mark, the I2, the re-crystallization in the tail of the mark led to a crescent mark, with a length shorter than the optical spot size. In this way, the tangential data density was increased.

It is an object of the invention to provide an alternative concept of thermal mastering, comprising a different recording stack, a different recording mechanism and a method of writing data in such a recording stack which leads to a high-density relief structure.

### SUMMARY OF THE INVENTION

The above objects are solved by the features of the independent claims. Further developments and preferred embodiments of the invention are outlined in the dependent claims.

In accordance with the invention, there is provided a recording stack for obtaining a high-density relief structure, comprising a first recording layer on top of a second recording layer, the recording layers being supported by a substrate layer, wherein, upon projecting light on the recording layers, a local interaction of the recording layers leads to marks on the basis of a local change of the properties with respect to chemical agents of the recording layers. Due to a laser induced heating the two recording layers are able to chemically interact with each other. In this way a mixed state is locally obtained. Since the mixed state has different properties in relation to chemical agents than adjacent regions, a relief structure can be manufactured by applying a chemical agent, i.e. a solvent to the illuminated recording stack. The recording layers have preferably the same thickness. A thickness between 10 and 60 nm is proposed. The lower values are proposed for shallow relief structures, for example, pre-grooved structures for rewritable or write-once discs, the higher values are meant for high-density pit structures.

According to a preferred embodiment, a heat-sink layer is arranged between the substrate and the adjacent recording layer. The heat-sink layer, which is generally provided as a metallic layer is able to remove excessive heat deposited in the recording stack due to the laser induced heating. Metal alloys comprising Ag, Al, etc. may be used for the heat sink layer. The thickness ranges between 20 and 150 nm, preferably between 50 and 100 nm.

Preferably, an interface layer is arranged between the heat-sink layer and the adjacent recording layer. Such an interface layer may serve as an etch stop in order to provide pits of a defined depth. Alternatively, the interface layer may be etchable as well in order to increase the depths of the pits. Conventional dielectric layers such as ZnS—SiO₂, SiC, Si₃N₄, A₁₂O₃ etc. are used as interface layers. The thickness ranges between 5 and 100 nm, preferably between 10 and 30 nm.

According to a further preferred embodiment, a protection layer is arranged on top of the recording stack. The protection layer is made of a material that well dissolves in the agents applied for preparing the relief structure. The layer is added to prevent a migration of any material during heating, which could mainly appear because of centrifugal forces during the rotation of the substrate. Further, the protection layer may be applied to improve the optical properties of the recording stack, with respect to reflection and absorption. The protection layer may be made of ZnS—SiO₂, photoresist, organic polymers like PMMA and dyes as well as thin metal sheets like Ag, Al, Cu etc. The thickness of the protection layer is preferably between 5 and 50 nm.

The invention is particularly advantageous in relation to an embodiment in which a stack of n pairs, n≧1, of first and second recording layers is provided. Thus, the present invention is not restricted to a single pair of recording layers, but rather a larger number of pairs can be provided, so as to be able to prepare deeper pits into the relief structure. The pairs of recording stacks, comprising the two recording layers, are possibly separated by interface layers.

According to a preferred embodiment, one of the recording layers comprises Cu and the other recording layer comprises Si. Due to the heating of the Cu layer as the first recording layer and the Si layer as the second recording layer a silicide is obtained that has different etch properties than the initial unwritten state. It is also possible to invert the order of appearance, i.e. the first recording layer comprises Si and the second recording layer comprises Cu. A different etch liquid is then needed to obtain a relief structure of the recorded stack.

According to a further preferred embodiment, one of the recording layers comprises Ni and the other recording layer comprises Si. Both orders of appearance as the first and the second recording layers are possible.

It is also possible that one of the recording layers comprises Co and the other recording layer comprises Si. Again, both orders of appearance as the first and the second recording layers are possible.

According to a still further preferred embodiment, one of the recording layers comprises Bi and the other recording layer comprises Sn. Also according to this embodiment both orders of appearance as the first and the second recording layers are possible.

According to another preferred embodiment, one of the recording layers comprises In and the other recording layer comprises Sn. Also in this example both orders of appearance as the first and the second recording layers are possible.

The invention is particularly advantageous in relation to an embodiment in which an interface layer is arranged between the first and second recording layers. An additional interface layer between the recording layers is used to provide more stability to the unwritten areas. The interface layer should break down at the recording temperatures, which are between 250 and 800° C., to then enable the required interlayer diffusion. The interface layer has a preferred thickness between 1 and 5 nm.

According to a preferred embodiment, the marks have a smaller dissolution rate with respect to a particular chemical agent than regions of the first recording layer adjacent to the marks. Thus, the unwritten first recording layer can be chemically removed so that a bump structure remains, the written marks representing these bumps. The height of the bumps equals the thickness of the first recording layer. An inverse replica of this bump structure contains pits with a depth equal to the thickness of the first recording layer.

According to a further preferred embodiment, the marks have a smaller dissolution rate with respect to a particular chemical agent than regions of the first and the second recording layers adjacent to the marks. On the basis of this embodiment, both the first and the second recording layers can be removed, leading to a relief structure having the height of both recording layers. The written marks are the bumps in this relief structure.

According to a still further preferred embodiment, the marks have a larger dissolution rate with respect to a particular chemical agent than regions of the first and the second recording layers adjacent to the marks. In this case, by etching a relief structure having a depth of the first and second recording layers is obtained. In contrast to the previously discussed embodiment, pits are obtained at the positions of the written marks.

According to another preferred embodiment, the marks and adjacent regions of the first recording layer have a larger dissolution rate than regions of the second recording layer adjacent to the marks. In this case, etching leads to a removal of the written marks and the first recording layer. Consequently, a relief structure with the height of the second recording layer remains with pits at the positions of the written marks.

The invention is particularly advantageous in relation to an embodiment in which the recording layers serve as a mask. Such a mask is provided for the further etching of underlying layers, particularly an interface layer or even the substrate.

In accordance with the invention, there is further provided a method of manufacturing a high density relief structure on a master substrate, the master substrate comprising a first recording layer on top of a second recording layer, the recording layers being supported by a substrate layer, the method comprising the steps of:

projecting light on the recording layers, thereby inducing a local interaction of the recording layers leading to marks on the basis of a local change of the properties with respect to chemical agents of the recording layers, and

treating the illuminated master substrate with a solvent, thereby obtaining a relief structure.

The local interaction is particularly induced by a local temperature rise.

The invention further relates to a method of producing an optical data carrier using a recording stack according to the present invention.

These and other aspects of the invention will be apparent from and elucidated with reference to the embodiments described hereinafter.

### BRIEF DESCRIPTION OF THE DRAWINGS

FIG. 1 shows a schematic cross section through a master substrate according to the present invention before processing;

FIG. 2 shows a schematic cross section through a master substrate according to the present invention with locally interacted regions;

FIG. 3 shows a schematic cross section through a first embodiment of a master substrate according to the present invention after being processed with an etch liquid;

FIG. 4 shows a schematic cross section through a second embodiment of a master substrate according to the present invention after being processed with an etch liquid;

FIG. 5 shows a schematic cross section through a third embodiment of a master substrate according to the present invention after being processed with an etch liquid;

FIG. 6 shows microscopic pictures illustrating traces written in accordance with the present invention;

FIG. 7 shows an AFM (atomic force microscope) measurement at the crossing of a written trace in a Cu—Si-recording stack after treatment with an etch liquid;

FIG. 8 shows a schematic cross section through a fourth embodiment of a master substrate according to the present invention after being processed with an etch liquid.

### DESCRIPTION OF PREFERRED EMBODIMENTS

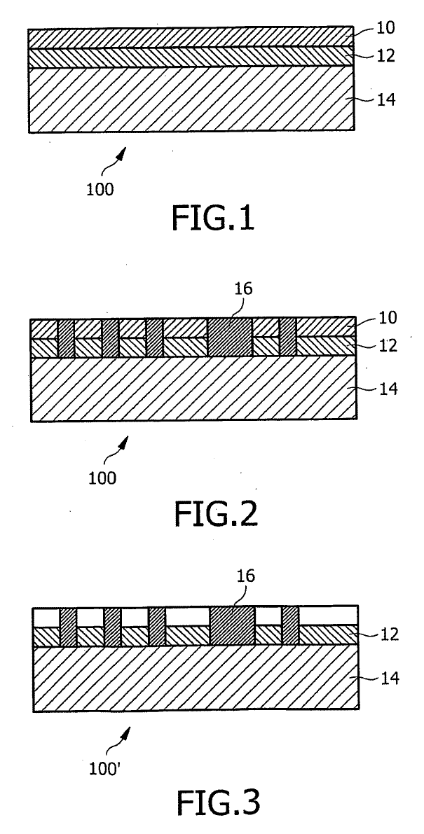

FIG. 1 shows a schematic cross section through a master substrate according to the present invention before processing. FIG. 2 shows a schematic cross section through a master substrate according to the present invention with locally interacted regions. The recording stack 100 comprises a first recording layer 10 on top of a second recording layer 12. The two recording layers 10, 12 are supported on a substrate 14. Additional layers, for example an interface layer between the recording layers 10, 12, a metallic heat sink layer between the substrate 14 and the second recording layer 12 and an interface layer between the second recording layer 12 and the heat sink layer, and a protection layer on top of the first recording layer 10 are not shown for the sake of simplicity. In order to prepare the recording stack 100 for etching a relief structure into the recording stack 100, a focused modulated laser beam is directed onto the top layer of the recording stack 100, thereby inducing a local heating and thus a thermally induced interaction between the recording stack materials. In the following, Cu and Si are taken as examples for the recording materials in the recording layers 10 and 12, respectively. Note that also other systems as Ni—Si, Co—Si, Bi—Sn, and In—Sn can be used as an alternative for the Cu—Si material system. The recording layers have preferably the same thickness. A thickness between 10 and 60 nm is preferred. The lower values are proposed for shallow relief structures, for example, pre-grooved structures for rewritable or write-once discs, the higher values are meant for high-density pit structures. The interface and metal layers are used to optimize the laser light absorption and to control the heat diffusion during writing of the data. Conventional dielectric layers such as ZnS—SiO₂, SiC, Si₃N₄, Al₂O₃ etc. are used as interface layer. The thickness ranges between 5 and 100 nm, preferably between 10 and 30 nm. Metal alloys comprising Ag, Al, etc. may be used for the metal layer. The thickness is between 20 and 150 nm, preferably between 50 and 100 nm. The resulting structure is shown in FIG. 2. Due to laser induced heating marks 16 that consist of a Cu silicide are generated.

FIG. 3 shows a schematic cross section through a first embodiment of a master substrate according to the present invention after being partly processed. In the case of this recording stack 100′, the unwritten first recording layer has been removed, and a bump structure remains. For example the unwritten Cu area is removed via etching with an acid solution, such as HNO₃, HCl, or H₂SO₄ (sulphuric acid). Other etch liquids may be possible as well. Suitable concentrations range between 1% and 50%. Silicon is insoluble for these etch liquids. The bumps are represented by the written marks 16. The height of the bumps equals the thickness of the first recording layer. An inverse replica of this bump structure contains pits with a depth equal to the thickness of the first recording layer.

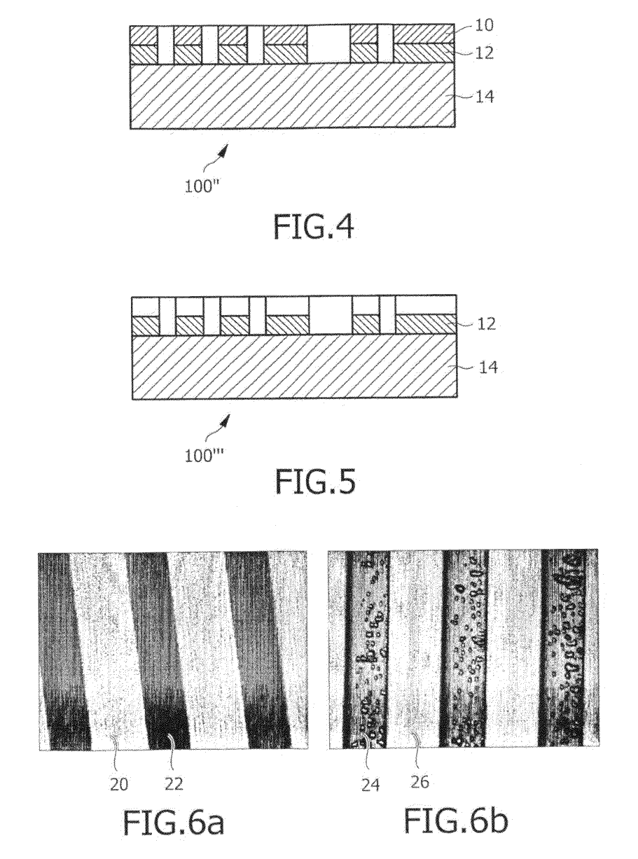

FIG. 4 shows a schematic cross section through a second embodiment of a master substrate according to the present invention after being partly processed. In the case of the recording stack 100″ depicted in FIG. 4, the written marks have a larger dissolution rate with respect to a particular agent than the adjacent regions of the recording layers 10, 12. Thus, a relief structure can be obtained that has a height of both recording layers 10, 12 taken together with pits at the original positions of the marks.

FIG. 5 shows a schematic cross section through a third embodiment of a master substrate according to the present invention after being partly processed. On the basis of the recording stack 100′″, a relief structure having a depth of the second recording layer 12 can be obtained. This is achieved by providing a second recording layer 12 that has a lower dissolution rate than the written marks and the first recording layer.

FIG. 6 shows an example of traces written in a Si—Cu recording stack. The traces were recorded at nominal write power (a: 15 nm Si layer and 15 nm Cu layer) and overpower (b: 40 nm Si layer and 40 nm Cu layer). The sample was not yet treated with an etch liquid. The write spot had a width of 100 μm, resulting in 100 μm wide traces in which the Si and Cu films have chemically interacted. The left image is an example of a well-written trace. The formed silicide, the written area 20, has a different optical contrast than the unwritten area 22. The recording stack had a 15 nm Cu and a 15 nm Si layer. The right image shows an example of an trace 24 written with overpower, leading to unwanted bubble formation in the recording stack; the thickness of the Si and Cu layers was 40 nm. The unwritten trace is shown at 26.

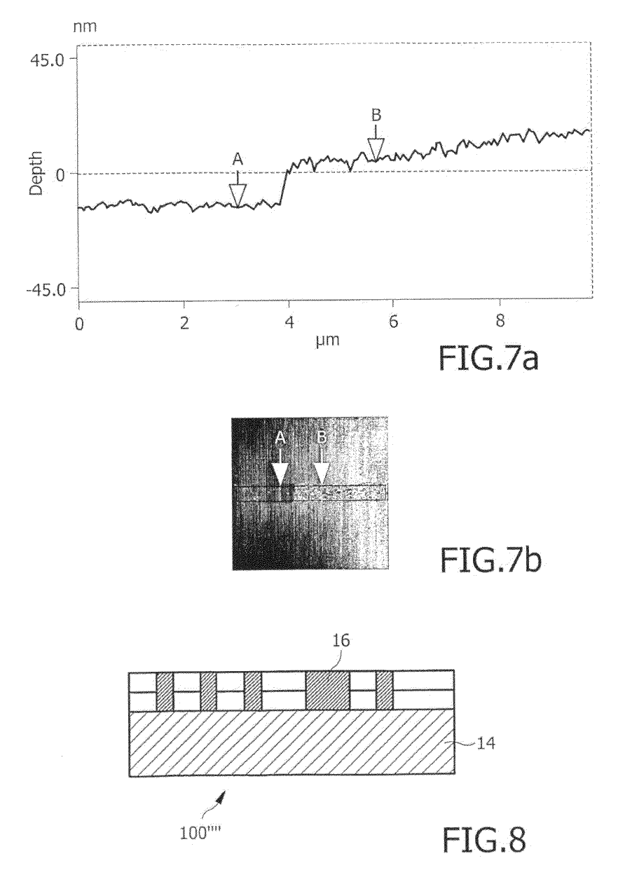

FIG. 7 shows an AFM measurement at the crossing of a written trace in a Cu—Si-recording stack after treatment with an etch liquid (5% HNO₃). The layer thickness of the Cu and Si film was 15 nm. The image (b) is a surface scan, the image (a) is an average cross-section of the lower image. The left plateau indicates the written phase (silicide), the right plateau refers to the initial phase. The image (b) partly shows the formed silicide (the left part of the image) and the initial recording stack (right part of the image). The corresponding points in images (a) and (b) are marked with A and B, respectively. From the observed step, it is concluded that the silicide (left plateau of the step) dissolves faster than the initial phase, where Cu is in contact with the dissolution liquid. The Cu plateau is rather rough, which is possibly caused by incomplete dissolution of Cu. If the dissolution time is extended, the Cu is completely removed and a smooth Si surface remains.

FIG. 8 shows a schematic cross section through a fourth embodiment of a master substrate according to the present invention after being partly processed. The recording stack 100″″ provides the possibility for obtaining a relief structure having a height of both recording layers taken together. This is achieved by providing materials that lead to marks having a lower dissolution rate than the recording layers.

Equivalents and modifications not described above may also be employed without departing from the scope of the invention, which is defined in the accompanying claims.

1. A recording stack for obtaining a high-density relief structure, comprising:
a first recording layer (10) on top of a second recording layer (12), the recording layers being supported by a substrate layer (14),
wherein, upon projecting light on the recording layers, a local interaction of the recording layers leads to marks (16) on the basis of a local change of the properties with respect to chemical agents of the recording layers.

2. The recording stack according to claim 1, wherein a heat-sink layer is arranged between the substrate (14) and the adjacent recording layer (12).

3. The recording stack according to claim 2, wherein an interface layer is arranged between the heat-sink layer and the adjacent recording layer (12).

4. The recording stack according to claim 1, wherein a protection layer is arranged on top of the recording stack.

5. The recording stack according to claim 1, wherein a stack of n pairs, n≧1, of first and second recording layers is provided.

6. The recording stack according to claim 5, wherein interface layers are provided between the pairs of recording layers.

7. The recording stack according to claim 1, wherein one of the recording layers comprises Cu and the other recording layer comprises Si.

8. The recording stack according to claim 1, wherein one of the recording layer comprises Ni and the other recording layer comprises Si.

9. The recording stack according to claim 1, wherein one of the recording layer comprises Co and the other recording layer comprises Si.

10. The recording stack according to claim 1, wherein one of the recording layer comprises Bi and the other recording layer comprises Sn.

11. The recording stack according to claim 1, wherein one of the recording layer comprises In and the other recording layer comprises Sn.

12. The recording stack according to claim 1, wherein an interface layer is arranged between the first and second recording layers.

13. The recording stack (100′) according to claim 1, wherein the marks have a smaller dissolution rate with respect to a particular chemical agent than regions of the first recording layer adjacent to the marks.

14. The recording stack (100″″) according to claim 1, wherein the marks have a smaller dissolution rate with respect to a particular chemical agent than regions of the first and the second recording layers adjacent to the marks.

15. The recording stack (100″) according to claim 1, wherein the marks have a larger dissolution rate with respect to a particular chemical agent than regions of the first and the second recording layers adjacent to the marks.

16. The recording stack (100′″) according to claim 1, wherein the marks and adjacent regions of the first recording layer have a larger dissolution rate than regions of the second recording layer adjacent to the marks.

17. The recording stack according to claim 1, wherein the recording layers serve as a mask.

18. A method of manufacturing a high density relief structure on a master substrate, the master substrate comprising a first recording layer (10) on top of a second recording layer (12), the recording layers being supported by a substrate layer (14), the method comprising the steps of:
projecting light on the recording layers, thereby inducing a local interaction of the recording layers leading to marks (16) on the basis of a local change of the properties with respect to chemical agents of the recording layers, and
treating the illuminated master substrate with a solvent, thereby obtaining a relief structure.

19. A method of producing an optical data carrier using a relief structure produced on the basis of a recording stack according to claim 1.
